(19) United States
(12) Patent Application Publication
(10) Pub. No.: US 2010/0001966 A1
(43) Pub. Date: Jan. 7, 2010

(54) Two dimensional application of a one dimensional touch sensor in a capacitive touchpad

(76) Inventors: Jia-Yih Lii, Taichung City (TW); Kuan-Chun Tang, Toufen Twonship (TW); Yen-Chang Chiu, Linkou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,333

(22) Filed: Apr. 6, 2009

(30) Foreign Application Priority Data
Jul. 4, 2008 (TW) 097112452

(51) Int. Cl. G06F 3/041

(52) U.S. Cl. 345/173

(57) ABSTRACT

A capacitive touchpad includes a controller, a plurality of scan lines and a plurality of sensor pads distributed over a one dimensional touch sensor. Each of the sensor pads is connected to the controller by a respective one of the scan lines to transmit a sensed value to the controller. The controller uses the sensed values and the positions of some of the sensor pads in an interpolation to determine the two dimensional coordinates of one or more touched positions. Based on the sensed values, the controller selects one or more of the sensor pads as one or more reference points for the interpolation.

### FIELD OF THE INVENTION

The present invention is related generally to a capacitive touchpad and, more particularly, to a two dimensional application of a one dimensional touch sensor in a capacitive touchpad.

### BACKGROUND OF THE INVENTION

In two dimensional applications, a capacitive touchpad is required to have excellent two dimensional positioning capabilities to provide accurate touch detection. Therefore, the existing capacitive touchpads always use a two dimensional touch sensor for touch positioning applications. FIG. 1 is a schematic diagram of a conventional capacitive touchpad having a two dimensional touch sensor, which includes two overlapped layers of sensor stripes in two directions and for convenience, referred to a first direction sensor and a second direction sensor. Each stripe of the first direction sensor is connected to a controller 12 by a scan line 14 to transmit a sensed value thereof to the controller 12, and so is each stripe of the second direction sensor (not shown the scan lines in figure). The controller 12 collects all the sensed values by scanning the scan lines of the first direction and second direction sensors, and thereby identifies the distributions of the sensed values, so as to determine a touched position on the capacitive touchpad 10. When there is only one touched position on the capacitive touchpad 10, the controller 12 can accurately position the two dimensional coordinates of the touched position and further obtain a position information of the user's finger touching on the capacitive touchpad 10. However, ghost positions may happen if two or more fingers simultaneously touch the capacitive touchpad 10. For example, two fingers 16 and 18 touching on the capacitive touchpad 10 as shown in FIG. 1 cause the sensed values in the first and second directions as shown at two sides of FIG. 1. From the distributions of the sensed values, the controller 12 can identify that there are two touched positions but cannot identify the relative relationship therebetween. As shown in FIG. 2, no matter the fingers 16 and 18 touch the capacitive touchpad 10 at positions (X1, Y1) and (X2, Y2) or at positions (X1, Y2) and (X2, Y1), the distributions of the sensed values are identical to those shown in FIG. 1. Therefore, the controller 12 is easy to mistake in judgment. If the positions (X1, Y1), (X2, Y1), (X1, Y2) and (X2, Y2) are touched at the same time, or any three of them are touched at the same time, the resultant distributions of the sensed values are also the same to those shown in FIG. 1. In other words, the controller 12 even cannot identify the number of the touched positions is two, three or four. Referring to FIG. 1 again, each stripe of the first direction sensor has a plurality of sensor pads in the first direction and all of them are connected to a same scan line 14. It is the same situation for each stripe of the second direction sensor. Thus, even though the sensor pads at different positions on a same sensor are touched, there is nothing different in the sensed values received by the controller 12. As a result, if the distributions of the sensed values scanned by the controller 12 show that there are two or more touched positions in both the first and second directions, the controller 12 will be unable to precisely identify the touched positions.

### SUMMARY OF THE INVENTION

An object of the present invention is to provide a two dimensional application of a one dimensional touch sensor in a capacitive touchpad.

Another object of the present invention is to provide a capacitive touchpad and a touch positioning method for a capacitive touchpad.

According to the present invention, a capacitive touchpad includes a controller connected with a plurality of sensor pads distributed over a one dimensional touch sensor by a plurality of scan lines. However, each of the sensor pad is independently connected to the controller by an individual scan line. In touch positioning, the controller uses the sensed values and the positions of some of the sensor pads in an interpolation to determine the two dimensional coordinates of one or more touched positions.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a schematic diagram of a conventional capacitive touchpad having a two dimensional touch sensor;

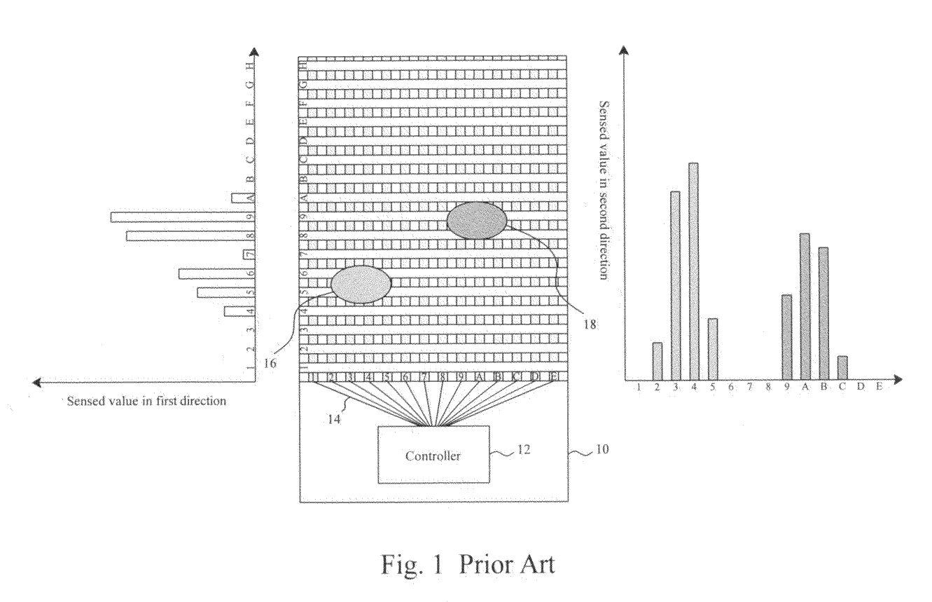

FIG. 2 is a schematic diagram showing ghost positions;

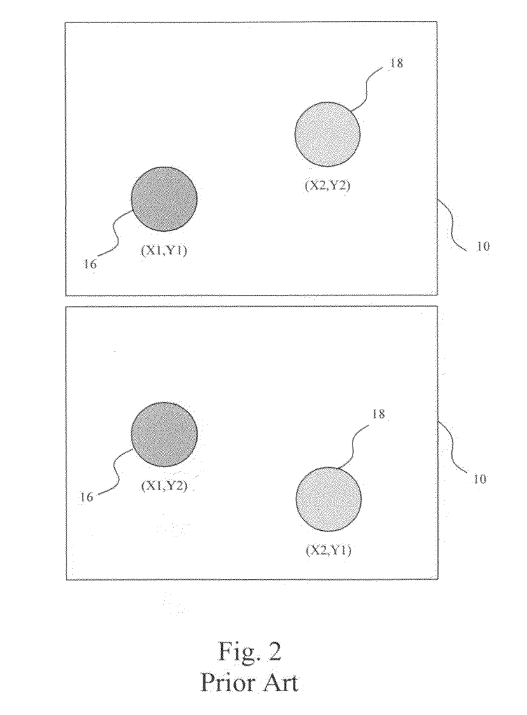

FIG. 3 is a schematic diagram of an embodiment according to the present invention;

FIG. 4 is a schematic diagram of a single finger detection on the capacitive touchpad of FIG. 3;

FIG. 5 is a schematic diagram of a two fingers detection on the capacitive touchpad of FIG. 3; and

FIG. 6 is schematic diagram of another two fingers detection on the capacitive touchpad of FIG. 3.

### DETAILED DESCRIPTION OF THE INVENTION

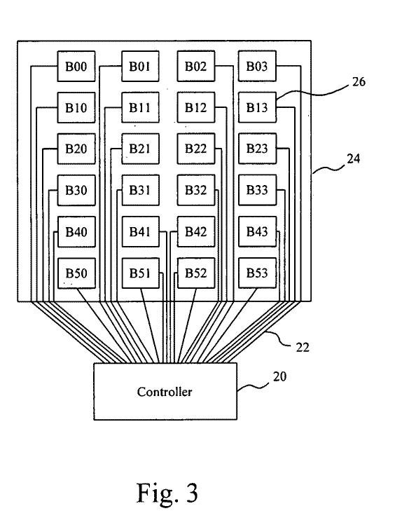

FIG. 3 is a schematic diagram of an embodiment according to the present invention, in which a capacitive touchpad 24 includes a plurality of sensor pads 26 made from a same conductor layer, whose positions are designated by B00-B53, and each of the sensor pads 26 is connected to a controller 20 by an individual scan line 22. When a conductor, e.g. a finger, touches the capacitive touchpad 24, the controller 20 will use the sensed values and the positions of some of the sensor pads 26 in an interpolation to determine the two dimensional coordinates of the touched position.

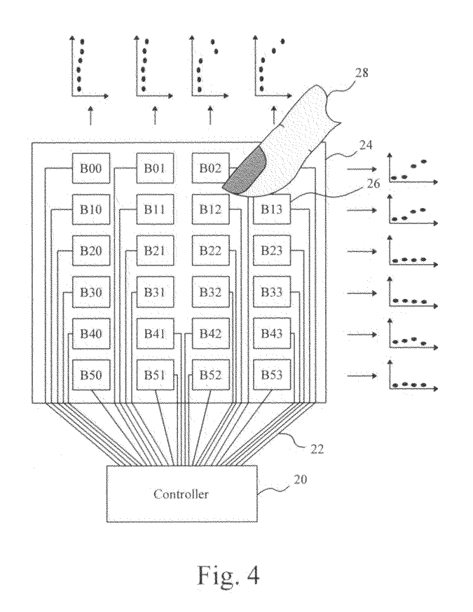

FIG. 4 is a schematic diagram of a single finger detection on the capacitive touchpad 24, in which the sensed values in a first direction are plotted above the capacitive touchpad 24 and the sensed values in a second direction are plotted to the right of the capacitive touchpad 24, each dot representing the sensed value of a sensor pad 26. From the sensed values, it is shown that the greatest sensed values in the first and second directions caused by a finger 28 are at B12 and B03, respectively, and B02 and B13 are the secondarily greatest in the two directions, respectively. For precisely determining the two dimensional coordinates of the finger 28, two approaches are provided, each of them includes an interpolation with sixty-four points. To simplify the following illustration, only equations for calculating for the coordinate in the second direction is provided below, and one skilled in the art would appreciate that those for the coordinate in the first direction can be deduced similarly.

In the first approach, the sensor pad 26 having the greatest sensed value is taken as a reference point. For example, in FIG. 4, the greatest sensed value in the second direction is at the position B03, so this position B03 is taken as the reference point for interpolation. Thus, it can obtain the coordinate in the second direction as

X=(B00×64+B01×64×2+B02×64×3+B03×64×4)/(B00+B01+B02+B03).

The coordinate in the first direction can also be derived by using the position B03 as the reference point for interpolation.

In the second approach, all the sensor pads 26 having sensed values greater than a threshold are taken as reference points for interpolation. For example, in FIG. 4, the sensed values at the positions B02, B03, B12 and B13 are all considered as being greater than a threshold because they are all significantly greater than those at the other sensor pads 26 that are not touched by the finger 28. Thus, the positions B02, B03, B12 and B13 are all used as reference points for interpolation, thereby obtaining the coordinate in the second direction as

X={[(B00×64+B01×64×2+B02×64×3+B03×64×4)/B00+B01+B02+B03)]+[(B10×64+B11×64×2+B12×64×3+B13×64×4)/(B10+B11+B12+B13)]}/2.

The coordinate of the first direction can be derived in the same manner.

Compared with the second touch positioning method, the first touch positioning method is simpler but sometimes might suffer a slight jump.

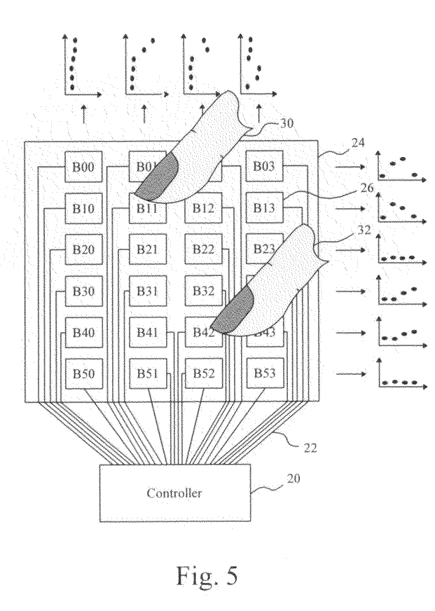

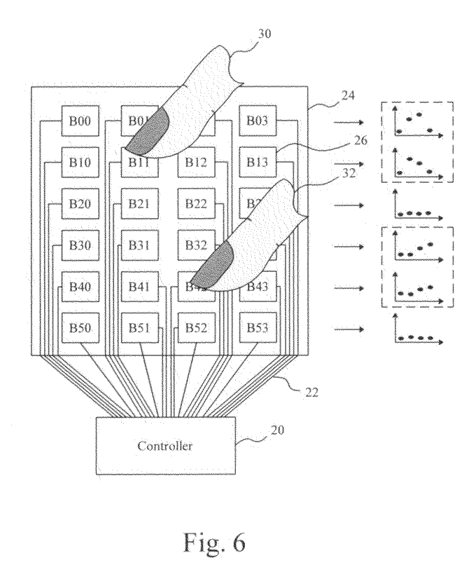

FIG. 5 is a schematic diagram of a two fingers detection on the capacitive touchpad 24 of FIG. 3, in which the sensed values caused by fingers 30 and 32 are plotted above and to the right of the capacitive touchpad 24. In this embodiment, similarly, the two dimensional coordinates of the touched positions are determined by an interpolation based on sixty-four points. Referring to FIG. 6, if the sensor pads 26 having the greatest sensed values are taken as the reference points for interpolation, the coordinates framed by dotted lines are the positions where the fingers 30 and 32 cause significant variation in the sensed values. The greatest sensed values in the second direction caused by the fingers 30 and 32 are at the positions B02 and B33, respectively. Thus, by taking the positions B00, B01, B02 and B03 into calculation, the coordinate of the finger 30 in the second direction is

X1=(B00×64+B01×64×2+B02×64×3+B03×64×4)/(B00+B01+B02+B03),

and by taking the positions B30, B31, B32 and B33 into calculation, the coordinate of the finger 32 in the second direction is

X2=(B30×64+B31×64×2+B32×64×3+B33×64×4)/(B30+B31+B32+B33).

The coordinate of the finger 30 in the first direction can be obtained by taking the positions B02, B12, B22, B32, B42 and B52 into calculation, and the coordinate of the finger 32 in the first direction can be obtained by taking the positions B03, B13, B23, B33, B43 and B53 into calculation.

When the second touch positioning method is employed, all the sensor pads 26 having sensed values greater than a threshold are taken as the reference points. For example, the positions B01, B02, B11 and B12 can be all used as the reference points to obtain the coordinate of the finger 30 in the second direction

X1={[(B00×64+B01×64×2+B02×64×3+B03×64×4)/(B00+B01+B02+B03)]+[(B10×64+B11×64×2+B12×64×3+B13×64×4)/(B10+B11+B12+B13)]}/2.

By taking the positions B32, B33, B42 and B43 as the reference points, the coordinate of the finger 32 in the second direction is

X2={[(B30×64+B31×64×2+B32×64×3+B33×64×4)/(B30+B31+B32+B33)]+[(B40×64+B41×64×2+B42×64×3+B43×64×4)/(B40+B41+B42+B43)]}/2.

In other embodiments, different number of interpolation points or different equations may be used for interpolation to determine the two dimensional coordinates of touched positions on a capacitive touchpad.

Assuming a user's finger has a diameter of 1 cm, each of the sensor pads 26 may be designed as 0.5×0.5 cm² to ensure that each finger contacts at least two of the sensor pads 26 in one touch, so that precise two dimensional coordinates can be obtained through interpolation. In other embodiments, the sensor pads 26 may be designed as having different sizes.

In another embodiment, the sensor pads 26 may be arranged as a matrix of a non-rectangular figure, and the two directions of the two dimensional coordinates may be not orthogonal to each other.

Since the manufacturing costs of a capacitive touchpad is mainly subject to the touch sensor it implements, the capacitive touchpad according to the present invention is advantageous in providing accurate two dimensional positioning by virtue only of a single layer touch sensor, thereby effectively reducing the manufacturing costs.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A capacitive touchpad having a one dimensional touch sensor for a two dimensional application, comprising:
a plurality of sensor pads distributed over the one dimensional touch sensor;
a controller; and
a plurality of scan lines, each connecting one of the sensor pads to the controller to transmit a sensed value to the controller;
wherein the controller uses the sensed values and the positions of some of the sensor pads in an interpolation to determine the two dimensional coordinates of one or more touched positions.

2. The capacitive touchpad of claim 1, wherein the controller selects one or more of the sensor pads as one or more reference points for the interpolation.

3. The capacitive touchpad of claim 1, wherein the controller selects the sensor pad having the greatest sensed value in a first direction as a reference point of the first direction and the sensor pad having the greatest sensed value in a second direction as a reference point of the second direction for the interpolation.

4. The capacitive touchpad of claim 1, wherein the controller selects the sensor pads having the sensed values in a first direction greater than a first threshold as reference points of the first direction and the sensor pads having the sensed values in a second direction greater than a second threshold as reference points of the second direction for the interpolation.

5. A touch positioning method for a capacitive touchpad, comprising:
retrieving the distributions of sensed values in a first direction and a second direction from a plurality of sensor pads distributed over a one dimensional touch sensor of the capacitive touchpad; and
using the sensed values and the positions of some of the sensor pads in an interpolation to determine the two dimensional coordinates of one or more touched positions.

6. The touch positioning method of claim 5, further comprising selecting one or more of the sensor pads as one or more reference points for the interpolation.

7. The touch positioning method of claim 5, further comprising selecting the sensor pad having the greatest sensed value in a first direction as a reference point of the first direction and the sensor pad having the greatest sensed value in a second direction as a reference point of the second direction for the interpolation.

8. The touch positioning method of claim 5, further comprising selecting the sensor pads having the sensed values in a first direction greater than a first threshold as reference points of the first direction and the sensor pads having the sensed values in a second direction greater than a second threshold as reference points of the second direction for the interpolation.
